(19) United States
(12) Patent Application Publication
(10) Pub. No.: US 2009/0045771 A1
(43) Pub. Date: Feb. 19, 2009

(54) CHARGER STAND FOR ELECTRICALLY HEATED ICE SKATES

(76) Inventors: Tory Weber, Calgary (CA); Benoit Talbot, St. Malachie (CA); David Croteau, Saint-Etienne (CA); Stephan Lachevrotiere, St. Augustin (CA); Pierre Harvey, St. Ferreol (CA)

Correspondence Address: ADE & COMPANY INC., 2157 Henderson Highway, WINNIPEG, MB, R2G1P9, CA

(21) Appl. No.: 11/839,166

(22) Filed: Aug. 15, 2007

(51) Int. Cl. H02J 7/02; H02J 7/00

(52) U.S. Cl. 320/103; 320/107

(57) ABSTRACT

A charger stand for a pair of electrically heated ice skates comprises a pair of channel shaped receptacles for receiving the skates in parallel side by side position with a housing for the charger electronics between the receptacles. A first connector connects to the blade and a second connector at the heel engaging portion touches a terminal on the skate heel. The blade is heated by a heating element encapsulated on the top edge of the blade in The?? battery pack is carried in the rear tower which is sealed against moisture penetration and includes two proximity switches for actuation.

This application is related to an application for U.S. Design Pat. No. 29/281,714 filed Jun. 29, 2007 by the same applicants and assigned to the present assignee which corresponds to Canadian application for Registered Design Pat. No. 121,254 filed on the same day.

### BACKGROUND OF THE INVENTION

Common ice skates used in skating have an elongate blade which is arranged to slide along the ice surface. Attempts to minimise the friction between the blade and the ice using heat are shown a number of U.S. patents. The blade when of the heated type also must be mounted in an effective manner which takes into account the provision of the heating and control circuits which become part of the system. A number of prior patents show mounting systems.

U.S. Pat. No. 3,119,921 (Czaja) issued Nov. 2, 1962 discloses a resistant heating element attached along a top of the blade on a skate with a battery mounted in the open area above the blade underneath the connection of the blade to the boot.

U.S. Pat. No. 3,866,927 (Tvengsberg) issued February 18 discloses a similar arrangement.

U.S. Pat. No. 5,441,305 (Tabar) issued Aug. 15, 1995 discloses a heating system primarily for skis which appears to be speculative in nature and includes a number of different arrangements which could be used.

U.S. Pat. No. 5,088,749 (Olivieri) issued Feb. 18, 1992 discloses a skate blade mounting system where a metal blade has hook portions along its top edge which are pulled tight onto the molded plastic base by a screw and lever arrangement.

U.S. Pat. No. 5,248,156 (Cann) issued Sep. 28, 1993 discloses a skate blade with a replaceable runner which is hooked at the font end and fastened by a screw at the rear.

U.S. Pat. No. 5,769,434 (Wurthner) issued Jul. 23, 1998 discloses a skate blade formed of a plastics material with a metal runner.

U.S. Pat. No. 6,523,835 (Lyden) issued Feb. 25, 2003 discloses a skate blade system where the blade can be manufactured from various composites and can be mounted using a hinging system.

US Published Application 2005/0029755 (Fask) published Feb. 10, 2005 discloses a skate blade including an injection molded steel runner which is screw fastened onto a plastic holder.

U.S. Pat. No. 6,669,209 issued Dec. 30 2003, U.S. Pat. No. 6,817,618 issued Nov. 16, 2004 and U.S. Pat. No. 6,988,735 issued Jan. 24, 2006 all by Furzer an all assigned to the present assignee disclose various arrangements of heated skate blade where a battery is located in a tower of the skate support attached to the skate boot and supplies power to a heating device on the blade. In particular U.S. Pat. No. 6,988,735 claims the concept of providing a charger for charging the battery which uses the skate blade itself as one contact and a connector which attaches to the skate body at a location separate from the blade. The arrangement disclosed includes a blade guard which attaches to the blade and a connector terminal which plugs into a receptacle on the skate body at the heel.

This application relates to the subject matter disclosed and claimed in co-pending applications Ser. No. 11/780577 entitled HEATING ARRANGEMENT FOR ICE SKATE BLADES (corresponding to Canadian Application INSERT) and Ser. No. 11/780580 entitled MOUNTING ARRANGEMENT FOR ICE SKATE BLADES (corresponding to Canadian Application INSERT)all filed 20 Jul. 2007 by the same applicants and assigned to the same assignees, the disclosures of which are incorporated herein by reference.

### SUMMARY OF THE INVENTION

It is an object of the present invention to provide charger stand for electrically heated ice skates which is more convenient for use.

According to a first aspect of the present invention there is provided a charger stand for a pair of electrically heated ice skates where each skate includes an electrical heating system and a battery for supplying power to the heating system, the charger stand comprising:

a stand body;

a first receptacle in the stand body for receiving a first skate of the pair;

a second receptacle in the stand body for receiving a second skate of the pair;

charger electronics for receiving electrical current from a power supply and for generating an output voltage for charging the battery of each of the first and second skates;

a pair of first connectors at the first receptacle for connecting the output voltage to the battery of the first skate;

and a pair of second connectors at the second receptacle for connecting the output voltage to the battery of the second skate.

The stand body may be an integral structure including the receptacles and formed from a molded plastic structure. However the receptacles may be formed separately and held together by a connecting structure formed independently of the receptacles themselves.

Preferably each of the first and second receptacles is shaped and arranged to engage and hold the respective skate in fixed position.

Preferably each of the first and second receptacles is arranged to hold the respective skate upright.

Preferably each of the first and second receptacles comprises a slot for receiving the blade therein and heel engaging portion for receiving a heel of the skate therein.

Preferably the first and second receptacles are arranged side by side to hold the skates parallel.

Preferably there is provided a housing for the charger electronics located between the receptacles.

Preferably each of the first and second receptacles comprises a heel engaging portion for receiving a heel of the skate therein and wherein the heel engaging portion stands up from a top of housing.

Preferably each receptacle has a flat base for resting on a support surface and the housing has an arched bottom surface extending between the two spaced flat bases.

Preferably each receptacle comprises a channel extending partly along sides of the respective skate to receive the heel and rear part of the skate.

Preferably a first connector of the pair is arranged to communicate to the skate blade and a second to a location on the skate separate from the skate blade.

Preferably there is provided a pair of skate blade holders each separate from and associated with a respective one of the receptacles and each arranged to engage a forward part of the skate blade of a respective one of the skates.

Preferably each of the skate blade holders includes front support legs for engaging a support surface for supporting the charger stand and for holding the front part of the skate blade elevated relative to the support surface.

Preferably each of the skate blade holders includes an engagement piece for connecting the skate blade holder to the respective receptacle and for applying a rearward force on the skate blade holder to apply pressure to the skate against the rear of the receptacle, the position of the engagement piece on the receptacle being adjustable to accommodate different size skates.

Preferably the charger electronics is arranged to provide a connection to a 12V power supply either directly from a battery connection or through a 120VAC to 12VDC converter.

According to a second aspect of the present invention there is provided a charger stand for at least one of a pair of electrically heated ice skate where the skate includes an electrical heating system and a battery for supplying power to the heating system, the charger stand comprising:

a stand body;

a receptacle in the stand body defined by a channel extending partly along sides of the skate to receive the heel and rear part of the skate;

the channel including a slot for receiving the blade therein and heel engaging portion for receiving a heel of the skate therein;

charger electronics for receiving electrical current from a power supply and for generating an output voltage for charging the battery of each of the first and second skates;

and a pair of connectors at the receptacle for connecting the output voltage to the battery of the skate.

### BRIEF DESCRIPTION OF THE DRAWINGS

In the accompanying drawings, which illustrate an exemplary embodiment of the present invention:

FIG. 1 is a bottom plan view of a heated skate blade, to be used with the charging stand of the present invention, showing the blade and mounting for attachment to a skate boot which is shown in outline only for convenience of illustration, and taken from the above co-pending applications of the present Applicants.

FIG. 2 is a side elevational view of the embodiment of FIG. 1 with the boot omitted for convenience of illustration.

FIG. 3 is a longitudinal cross sectional of the embodiment of FIG. 1.

FIG. 4 is an isometric view of the charging stand according to the present invention including a pair of skates of the type shown in FIGS. 1 to 3.

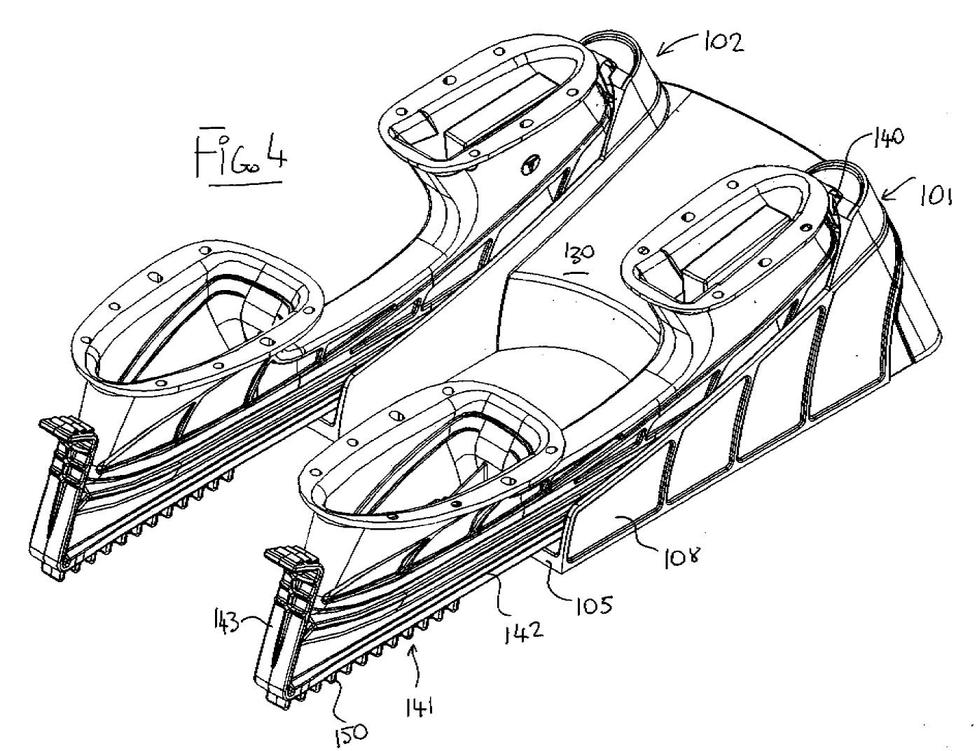

FIG. 5 is an isometric view of the stand alone of FIG. 4.

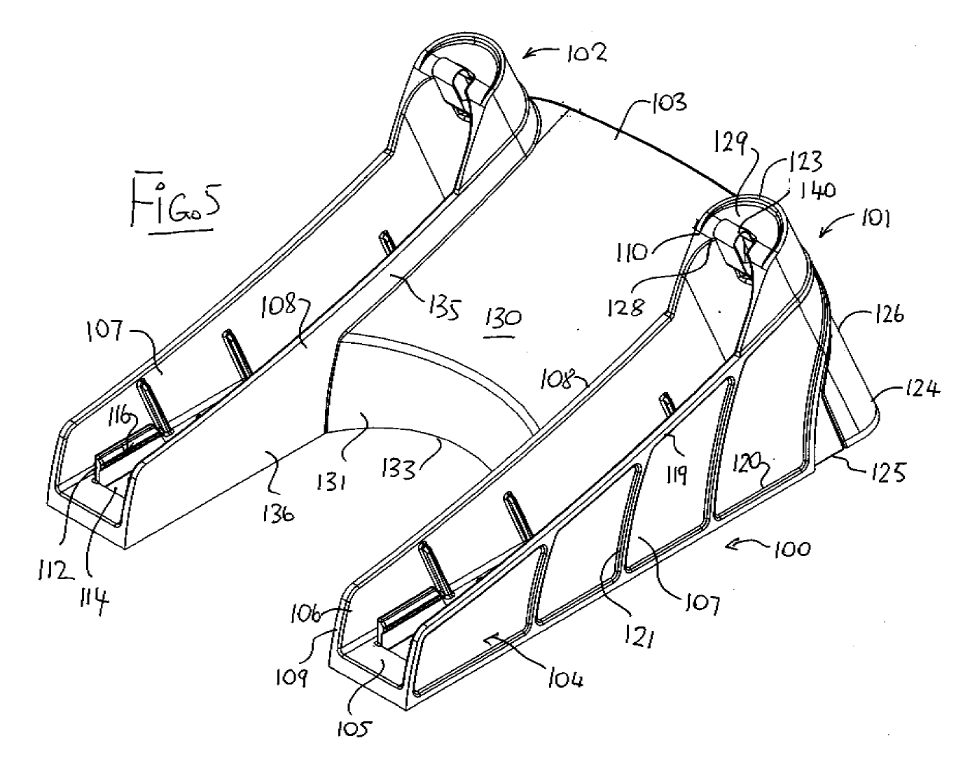

FIG. 6 is a top plan view of the stand alone of FIG. 4.

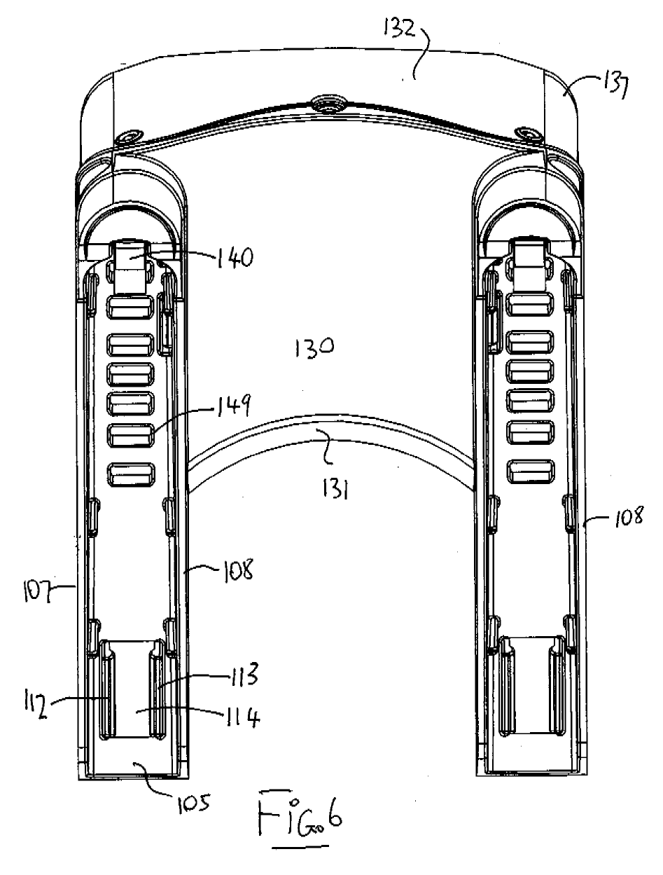

FIG. 7 is a front elevational view of the stand alone of FIG. 4.

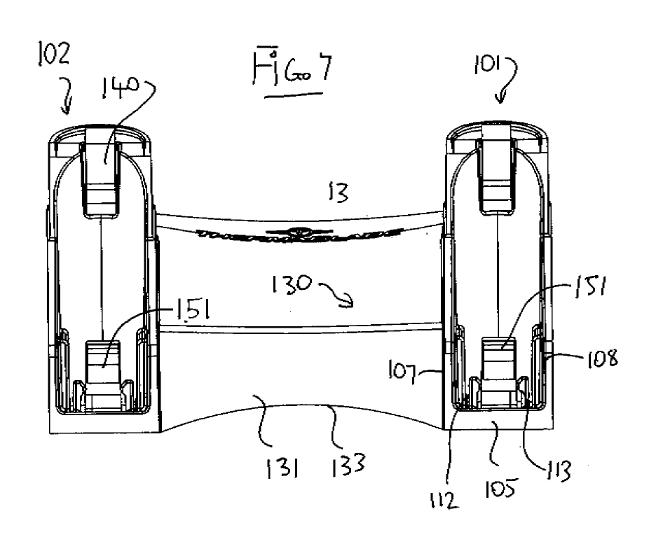

FIG. 8 is a rear elevational view of the stand alone of FIG. 4.

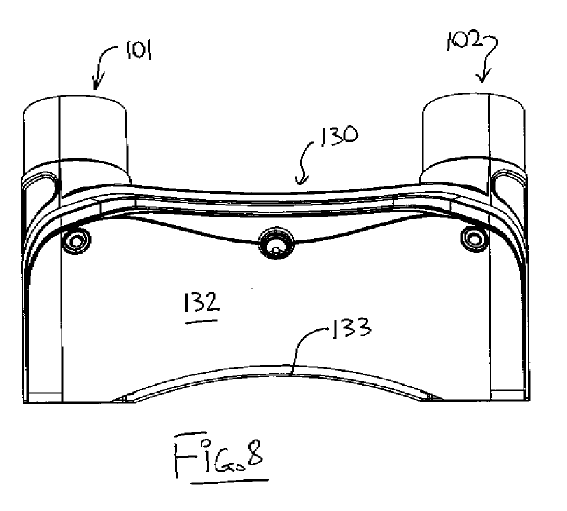

FIG. 9 is a cross-sectional view along a center line of one of the skates and receptacles of the skates and stand of FIG. 4.

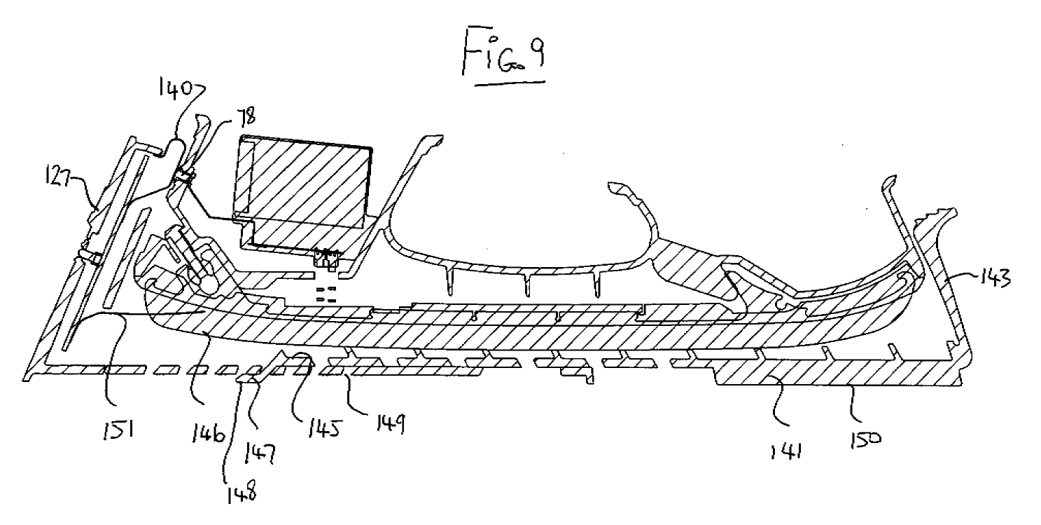

### DETAILED DESCRIPTION

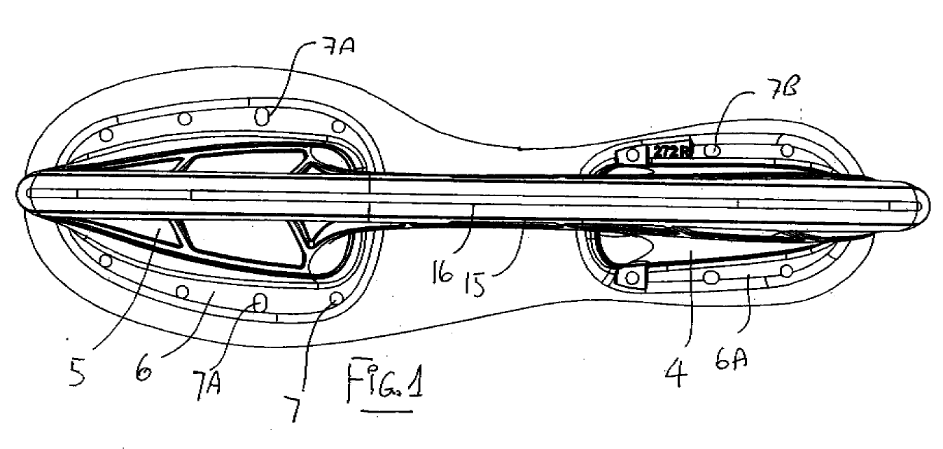

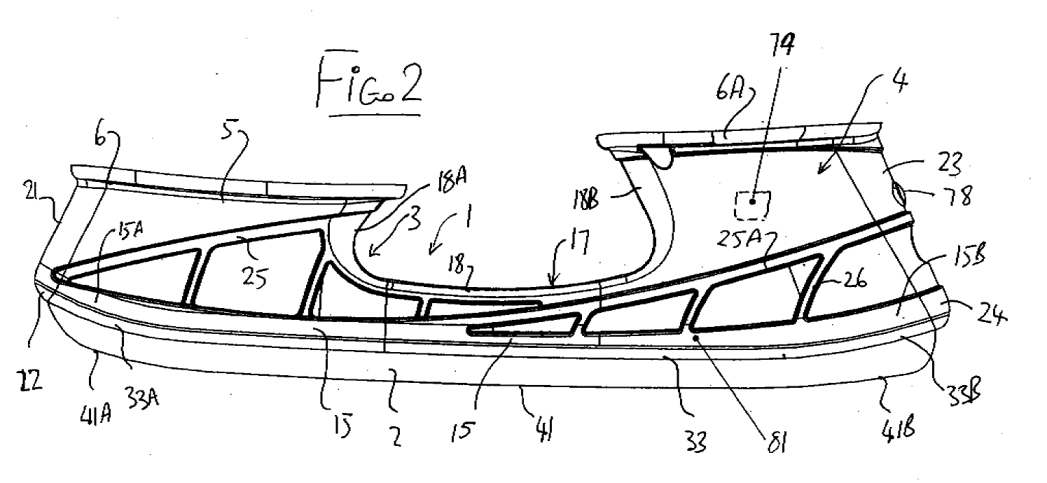

For completeness the skate with which the charging stand is intended to be used is now described using the drawings and description taken form the above co-pending applications. Thus, referring to the accompanying drawings FIGS. 1 and 2, there is illustrated an ice skate blade assembly 1. The skate blade assembly is of the conventional ice skate type having a blade 2 and a holder 3 to support the blade. The holder has a hollow heel tower 4 and a hollow toe tower 5 each having a top flange 6, 6A around the peripheral edge of the tower which fastens to the skate boot by a series of holes 7 around the flange.

The skate blade assembly 1 is generally fastened through the sole plate flange holes 7 through matching holes in the sole of an ice skate boot (not shown) with mechanical fasteners (not shown). The heel 4 and the toe 5 of the skate blade holder 3 generally are hollow.

A heating arrangement 8 is arranged to heat the skate blade 2 such that the heat reduces the coefficient of friction of the blade 2 on an ice surface.

The heating arrangement 8 has a heat control circuit board 9 mounted on the top edge of the blade and a battery 14 and battery control circuit board 14A in the hollow heel tower 4 of the holder 3.

A number of different possibilities for generating heat for the blade can be used. In one option, the heating system uses a series of transistors 12 arranged at spaced portions along the top edge of the blade within the central area between the two mounting towers 4 and 5. Each transistor is mounted on an upwardly projecting portion of the metal blade so as to communicate heat thereto. The circuit has a thermistor 12A which controls the temperature of the blade by controlling gate voltage to the transistors. In practice the blade temperature is maintained just above freezing at a temperature of the order of 2 to 10 degrees Celsius and preferably of the order of 4 to 6 degrees. In many cases where the player is off the ice for a short break as in regular shifts in a hockey game, the temperature of the box or other rest area is often sufficiently high that the heater is turned off during the break period off the ice and only turns back on when the player or skater is back on the ice for a sufficient period to cool the blade down to the temperature below the set temperature. This ensures that the heater is used only when required on the ice and the battery power is not wasted when the player is off the ice. This avoids the use of motion sensors or other timing devices to control the heat application.

By taking the transistors 12 into the linear region of operation, a high efficiency heat source is produced. The power source is a rechargeable battery 14 and is regulated for circuit operation and used to supply the transistors 12, which are preferably a field effect transistor (FET) or a power MOS-FET. However conventional bipolar junction type transistor can also be used.

The holder 3 defines an elongate bottom section 15 which extends along the full length of the holder and defines along a center thereof a slot 16 for receiving the blade. The elongate member 15 is connected to the hollow towers 4 and 5 so that the towers converge downwardly and inwardly from the top flange 6, 6A toward the bottom elongate member 15. At the bottom member 15, the moulded body forming the holder is solid and this solid structure extends upwardly into the structure of the holder until the width expands sufficiently to allow the structure to be formed into the hollow towers 4 and 5 while providing sufficient strength within the holder body from the moulded plastics material.

Between the hollow towers, the holder includes a U-shaped area 17 defining a top edge 18 which is the top edge of the solid part of the body on which the bottom member 15 is formed. The top surface 18 curves upwardly at the forward end to form a wall 18A which is the rear wall of the front tower 5. Similarly the top 18 at its rear curves upwardly to form a upward and forwardly extending portion 18B which forms the front wall of the rear tower 4. The front tower 5 thus has a rear end at the rear end of the flange 6 which overlies the surface 18 and symmetrically a forward end of the flange 6A of the tower 4 also overlies the surface 18.

The front tower 5 has a front wall 21 which extends downwardly to a forward end 22 of the member 15. The rear tower 4 has a rear wall 23 which extends downwardly to a rear end 24 of the member 15. The wall extending upwardly from the member 15 to the base of the towers includes side ribs 25 which extend upwardly and rearwardly as indicated at 25 and 25A together with downwardly extending ribs 26 which connect from the inclined ribs 25 and 25A to the bottom end 15 to provide an attractive appearance.

The member 15 defines a slot 16 in its bottom surface. This slot provides a receptacle for the blade so that the blade may be inserted into this slot and pulled up into the slot to be held in fixed position on the bottom of the member 15 and held against side to side movement by engagement between the blade and the slot.

The blade 2 includes a steel blade portion 32 and an over-molded portion 33 of a plastics material. The over-moulded portion is moulded onto the sides of the steel blade 32 and across the top edge of the steel blade 32 so as to form a structural member rigidly and permanently attached to the steel blade and extending out to each side of the steel blade. The steel blade 32 engages into the over-molded plastics portion 33 so that it is held in place within that plastics portion.

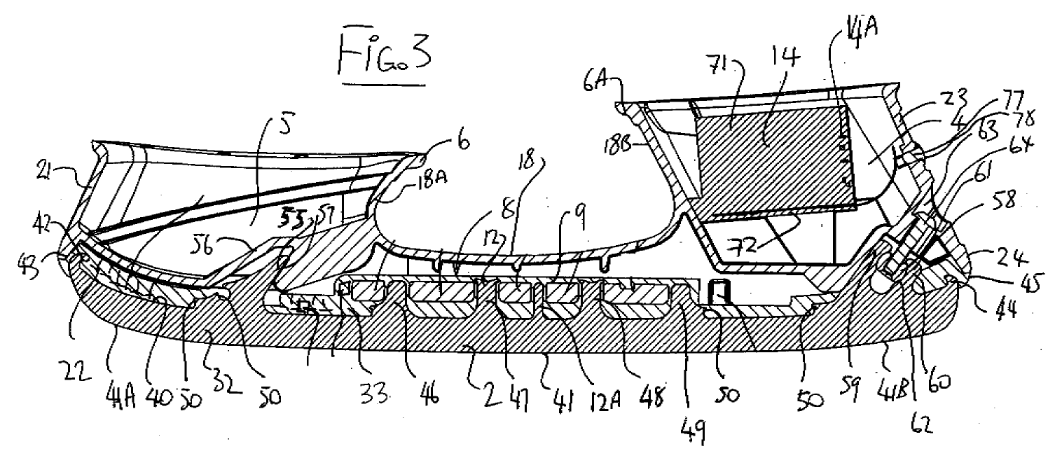

As best shown in FIG. 3, the steel blade 32 includes a top edge 40 which has a complex shape for engagement into the over-molded plastics portion 33. The steel blade 32 has a bottom edge 41 which forms the skate blade edge of a conventional shape with slightly upwardly curved front and rear portions 41A and 41B.

The complex upper edge 40 of the steel blade portion is shaped to define a series of hooks which engage into the over-molded plastics portion 33 to maintain permanent engagement therewith. Thus there is a front hook 42 at the forwardmost end of the steel blade and this is received just behind the front edge 43 of the over-molded plastics piece so that it is embedded in the plastics piece and acts to retain the blade within that plastics piece. Similarly there is a rear hook 44 which engages into the plastics piece just in front of the rear edge 45 of the over-molded plastics piece.

The steel blade further includes upwardly projecting elements 46, 47, 48 and 49 in the center section under the surface 18 which project into the area at the transistors 12 to which they are attached. Some of these upwardly projecting members such as the members 47 and 48 have upper hooks which extend forwardly and rearwardly respectively for engaging into the plastics material to provide further engagement therewith. Further upwardly projecting portions 50 at spaced positions along the length of the blade also provide further engagement into the plastics material. The thermistor 12 is mounted on a central one of the projecting elements 12A.

Thus at some locations the blade extends only a short distance into the plastics material. However at other locations along the blade, the blade extends through the moulded portion 33 to provide components projecting beyond the plastics portion.

The steel blade includes a front engagement portion 55 which projects through the over-molded plastics portion 33 to provide an engagement hook member which extends into a receptacle 56 in the support. The hook member 55 has a rear surface 57 which extends upwardly and rearwardly so as to butt against a correspondingly inclined surface of the receptacle 56. It will be appreciated therefore that rearward pulling action on the blade 2 will cause the inclined surfaces to pull the blade upwardly into the slot 16 so as to force the shoulders of the blade against the shoulders at the base of the member 15.

The rearward pulling action on the blade is provided by a rear mounting member 58 of the blade. The rear mounting member 58 also projects upwardly through the over-molded plastics member 33 to provide an upwardly extending portion above that member. The rear mounting 58 includes two arms 59 and 60 between which is mounted a nut 61 received in a cylindrical bearing surface 62 allowing the nut to swivel about an axis at right angles to the axis of the nut. Thus the nut has a cylindrical outer surface which is contained within the cylindrical bearing surface 62 allowing this pivotal action to accommodate slight inaccuracies in the positioning of the blade relative to the holder. The rear wall 23 of the rear tower 4 has a recesses hole 63 for receiving a screw 64. The screw has a head which engages against a base of the recessed hole so that the screw can engage into the nut and by turning the screw the nut is pulled upwardly and rearwardly as the screw head butts against the shoulders on either side of the hole. Thus the turning of the screw 64 acts to pull the blade upwardly and rearwardly along the slot 16 so as to pull the rear part of the blade into the slot and so as to pull the blade rearwardly along the slot to force the front mounting portion 55 into the receptacle 56.

Thus the blade can be mounted on the holder by releasing the screw and by removing the projecting portion of the moulded plastics portion 33 from the slot by pulling the blade downwardly. The blade can be reinserted by simply inserting the blade approximately into its required position thus sliding the front member 55 into the receptacle 56 whereupon the screw and be inserted into the nut and the blade pulled up into place both longitudinally and upwardly.

As best shown in FIG. 2, the bottom edge 41 of the blade curves upwardly and forwardly at the front end 41A and curves upwardly and rearwardly at the rear end 41B. The over-molded portion 33 similarly is curved upwardly at the forward end at 33A and is curved upwardly at the rearward end as indicated at 33B. Also following the same curvature, the bottom edge of the member 15 also curves upwardly and forwardly at the forward end indicated at 15A and upwardly and rearwardly at the rearward end indicated at 15B. In this way the blade and the over-molded portion 33 fit effectively into the slot 16 of the member 15 along the full length of the blade.

The towers 4 and 5 are arranged to extend upwardly to a position to engage the bottom of a conventional skate boot. It will be appreciated that in practice the heated skate blade arrangement of the present invention can be constructed as a separate item for attachment to boots manufactured by skate manufacturers so that the heated skate itself can be supplied to a number of different manufactures for use with their skate boots.

The tower 5 at the front is of reduced height relative to the tower 4 at the rear. Thus as is conventional the heel part of the boot is elevated above the toe part of the boot allowing the top flanges 6 and 6A to be attached directly to the bottom surface of the boot without the presence of a heel structure underneath the boot between the rear part of the boot and the top flange 6A.

The flange 6 surrounding the tower 5 is shaped so as to follow approximately the shape of the sole part of the boot and thus is slightly wider than the heel part of the boot at the flange 6A of the tower 4.

Each of the flanges includes a series of holes along the flanges on each side of the hollow tower and these holes are arranged to be fastened to the boot by rivets engaged through the flange from the underside and engaging into the receiving holes in the base of the boot.

Thus the sole has four receiving holes along each side for receiving the four holes of the flange 6. The rear part of the boot has three receiving holes on each side for receiving the rivets from the flange 6A.

The battery power supply 14 includes a battery 71 and a battery control circuit board 72 located underneath the battery. A conventional battery protection circuit 14A is part of the battery since the batteries are sold with this little circuit incorporated in the battery enclosure. The battery control circuit 72 carries the components for controlling the supply of power from the battery including a low power indicator. The battery 71 and the circuit board 72 are contained within an encapsulating material as an enclosed separate item which can be inserted into the hollow tower as an integral element to be contained therein. The encapsulated battery power supply includes a pair of terminals which are arranged to be connected to the blade for communication of current from the battery power supply to the heat control circuit carried on the blade.

The battery power supply further includes a further terminal 76 in the form of a spring finger which extends from one end of the battery control circuit board for engagement with a stud or rivet 77 carried in the tower as best shown in FIG. 3 where the stud has a head 78 exposed at the rear wall 23 of the tower for engaging a charging system.

A charging system for the skate can therefore comprise components which have a first terminal for engagement with the blade 32 and a second terminal for engagement with the head 78 of the stud 77. This provides a connection to the battery power supply through the battery control circuit 72. The transistors are connected to the metal blade so that current can flow from the metal blade 32 through the circuit of the heating control circuit board 70 to the battery control circuit board 72 then to the battery 14 through a wire. The opposite connection of the charging power supply provides a connection through the stud 77 and the spring terminal 76 into the battery control circuit board 72 then to the battery 14 through a wire to provide the charging action.

Turning now to the Charging Stand generally indicated at 100, this comprises a first receptacle 101 for a first one of the skates and a second receptacle 102 for the other one of the skates. Between the two receptacles is provided a housing 103 for the charger electronics. The electronics for the charger are of course conventional and widely used in many different charging systems. The charger electronics provides a system which receives current from a suitable power supply using a 120VAC to 12VDC transformer or can be direct from a 12 volt DC supply for example from a car battery or from a suitable connector within the vehicle. The connection cord is not shown and the details of the electronics are not shown as these are of course conventional.

The receptacles are symmetrical and opposite and arranged on opposite sides of the housing 103. Each receptacle comprises a generally channel shaped body 104 defined by a base 105 and upstanding side walls 106 and 107. The side walls have top edges 108 which increase gradually in height from a vertical front edge 109 upwardly and rearwardly to a rear heel receiving portion 110. The side walls 106 and 107 are generally parallel and upright. The base 105 includes a pair of upstanding guide walls 112 and 113 which are separated by a centre portion 114 of the base 105 thus defining a generally rectangular slot 116. The walls 112 and 113 extend along the base 105 to a rear end 117 which is spaced forwardly from the heel receptacle portion 110. The side wall 107 which is the outer side wall has a peripheral rib 119 on the outer surface extending along the top edge together with a bottom rib 120 along the bottom edge and vertical ribs 121 standing upwardly therebetween to provide an attractive appearance for the outer wall and to provide additional stiffening for the outer wall. A rearmost one of the most upstanding ribs 122 extends upwardly and around the rear of the heel engaging portion 110.

The heel engaging portion includes a top edge 123 and extends from that top end downwardly and rearwardly to a rear end 124 at a flat base 125 which defines the bottom wall 105 which stands on a support surface. Thus the rear wall extending from the rear end 124 upwardly and forwardly as indicated at 126 extends upwardly and forwardly to the top edge so as to follow generally the shape of the rear wall of the skate as shown in FIGS. 2 or 3. The rear heel receiving portion includes also an inner wall 127 which commences at an upper edge 128 and extends parallel to the rear wall 126. The rear of the heel of the skate therefore engages against the rear wall 127 which curves around the heel to match the curvature in a horizontal plane as inclined downwardly and rearwardly to match the shape of the heel in inclination. Between the rear edge 123 and the top edge 128 of the rear wall 127 is a forwardly and downwardly inclined top wall 129.

The housing 103 includes a top wall 130, a front wall 131, a rear wall 132, and a bottom wall 133. The top wall 130 is recessed downwardly from the top edge of the wall 108 so as to define a portion 135 of the wall 108 which stands upwardly from the top wall 130. The front wall 131 is recessed rearwardly from the front edge 109 so that the front wall leaves a space between the walls 108 as indicated at 136. The rear wall 132 smoothly curves at the sides 137 into the outer wall 108 at the rear heel portion. The bottom wall 133 is arched between the two flat base portions 105 of the two skate receptacles so that the bottom surface 133 is raised away from the support surface on which the base 105 sits. This allows the user to pick-up the stand simply by sliding the fingers over the flat surface on which the stand is placed so as to reach below the central housing and to lift the central housing thus carrying the two skate receptacles and the whole stand from place to place.

The electronic components providing the charging system contained within the housing are arranged to provide an output voltage at a required voltage level to charge the battery system of the skate. The electronic components thus receive the power from the power supply either and convert that to a required power output to supply to the skate.

Each skate when supported in the receptacle of the stand is carried in a respective one of a pair of skate blade holders or guards 141 each separate from and associated with the respective one of the receptacles and each arranged to engage a forward part of the skate blade of a respective one of the skates. Each of the skate blade holders includes an elongate body 142 in the form of a strip which has a slot for receiving the skate blade. An upturned front portion 143 can be grasped by the user to pull the holder onto and from the blade. The upturned front end also prevents the blade from moving forward relative to the holder.

The holder extends rearwardly to a rear end 145 which is spaced forwardly of the rear end of the blade so that the rear part of the blade is exposed as indicated at 146.

At the rear end 145 is provided an engagement piece 147 for connecting the skate blade holder to the respective receptacle and for applying a rearward force on the skate blade holder to apply pressure to the skate against the rear of the receptacle. The engagement piece 147 includes a down-turned leg 148 which engages through a selected one of a series of holes 149 along the base of the receptacle so that the position of the engagement piece on the receptacle is adjustable longitudinally to accommodate different size skates.

The holder extends forwardly from the front end of the channel forming the receptacle and defines a front support leg 150 or legs for engaging a support surface for supporting the charger stand and for holding the front part of the skate blade elevated relative to the support surface.

The output of the charger is communicated through the body of the stand to a pair of contact terminals located in the skate receptacles. A first one of the contact terminals is located on the rear wall 127 as indicated at 140 for engaging the stud 78 of the heel of the skate blade support.

A second contact 151 is arranged to contact the exposed portion 146 of the skate blade and comprises a flexible finger which extends from the rear wall 127 forward to be depressed by contact with the bottom edge of the skate blade. The downward pressure on the rear part of the skate blade caused by lifting the front end of the holder presses the skate blade downwardly onto the flex finger 151. The rearward pressure obtained by adjusting the holder in the receptacles and the engagement of the front end of the holder against the front end of the blade presses the stud 78 against the flex contact 140.

The skates can be therefore removed from the feet by detaching the boots from the feet. The boots are of course not shown in the drawing for convenience of illustration. The stand can then be simply provided at a suitable location with power supply to the charging electronics in the housing and the skates simply inserted into the receptacles. The holders are attached and they slide into the slots so that the terminal connects to the skate guard and through the metal component of the skate guard to the blade with the heel terminal provided by the stud 78 attaching onto the terminal 140.

1. A charger stand for a pair of electrically heated ice skates where each skate includes an electrical heating system and a battery for supplying power to the heating system, the charger stand comprising:
a stand body;
a first receptacle in the stand body for receiving a first skate of the pair;
a second receptacle in the stand body for receiving a second skate of the pair;
charger electronics for receiving electrical current from a power supply and for generating an output voltage for charging the battery of each of the first and second skates;
a pair of first connectors at the first receptacle for connecting the output voltage to the battery of the first skate;
and a pair of second connectors at the second receptacle for connecting the output voltage to the battery of the second skate.

2. The charger stand according to claim 1 wherein each of the first and second receptacles is arranged to hold the respective skate in fixed position.

3. The charger stand according to claim 1 wherein each of the first and second receptacles is arranged to hold the respective skate upright.

4. The charger stand according to claim 1 wherein each of the first and second receptacles comprises a slot for receiving the blade therein and heel engaging portion for receiving a heel of the skate therein.

5. The charger stand according to claim 1 wherein the first and second receptacles are arranged side by side to hold the skates parallel.

6. The charger stand according to claim 5 wherein there is provided a housing for the charger electronics located between the receptacles.

7. The charger stand according to claim 6 wherein each of the first and second receptacles comprises a heel engaging portion for receiving a heel of the skate therein and wherein the heel engaging portion stands up from a top of housing.

8. The charger stand according to claim 6 wherein each receptacle has a flat base for resting on a support surface and the housing has an arched bottom surface extending between the two spaced flat bases.

9. The charger stand according to claim 6 wherein each receptacle comprises a channel extending partly along sides of the respective skate to receive the heel and rear part of the skate.

10. The charger stand according to claim 1 wherein for each pair of connectors a first connector of the pair is arranged to communicate to the skate blade and a second to a location on the skate separate from the skate blade.

11. The charger stand according to claim 1 wherein there is provided a pair of skate blade holders each separate from and associated with a respective one of the receptacles and each arranged to engage a forward part of the skate blade of a respective one of the skates.

12. The charger stand according to claim 11 wherein each of the skate blade holders includes front support legs for engaging a support surface for supporting the charger stand and for holding the front part of the skate blade elevated relative to the support surface.

13. The charger stand according to claim 11 wherein each of the skate blade holders includes an engagement piece for connecting the skate blade holder to the respective receptacle and for applying a rearward force on the skate blade holder to apply pressure to the skate against the rear of the receptacle, the position of the engagement piece on the receptacle being adjustable to accommodate different size skates.

14. The charger stand according to claim 1 wherein there is provided a connection to a 12V power supply either directly from a battery connection or through a 120VAC to 12VDC converter.

15. A charger stand for at least one of a pair of electrically heated ice skate where the skate includes an electrical heating system and a battery for supplying power to the heating system, the charger stand comprising:
a stand body;
a receptacle in the stand body defined by a channel extending partly along sides of the skate to receive the heel and rear part of the skate;
the channel including a slot for receiving the blade therein and heel engaging portion for receiving a heel of the skate therein;
charger electronics for receiving electrical current from a power supply and for generating an output voltage for charging the battery of each of the first and second skates;
and a pair of connectors at the receptacle for connecting the output voltage to the battery of the skate.

16. The charger stand according to claim 15 wherein a first connector of the pair is arranged to communicate to the skate blade and a second connector to a location on the skate separate from the skate blade.

17. The charger stand according to claim 15 wherein there is provided a skate blade holder separate from and associated with the receptacle and arranged to engage a forward part of the skate blade of a respective one of the skates.

18. The charger stand according to claim 17 wherein the skate blade holder includes front support legs for engaging a support surface for supporting the charger stand and for holding the front part of the skate blade elevated relative to the support surface.

19. The charger stand according to claim 17 wherein the skate blade holder includes an engagement piece for connecting the skate blade holder to the receptacle and for applying a rearward force on the skate blade holder to apply pressure to the skate against the rear of the receptacle, the position of the engagement piece on the receptacle being adjustable to accommodate different size skates.
